(19) United States
(12) Patent Application Publication
(10) Pub. No.: US 2020/0145143 A1
(43) Pub. Date: May 7, 2020

(54) Methods And Apparatus For HARQ Procedure And PUCCH Resource Selection In Mobile Communications

(71) Applicant: MediaTek Singapore Pte. Ltd., Singapore (SG)

(72) Inventors: Jozsef Nemeth, Cambridge (GB); Mohammed S Aleabe Al-Imari, Cambridge (GB); Abdelkader Medles, Cambridge (GB)

(21) Appl. No.: 16/667,904

(22) Filed: Oct. 30, 2019

Related U.S. Application Data
(60) Provisional application No. 62/754,009, filed on Nov. 1, 2018.

(51) Int. Cl. H04L 1/18; H04W 72/04; H04L 5/00; H04W 76/27

(52) U.S. Cl. CPC H04L 1/1819; H04W 72/0446; H04W 76/27; H04L 5/0055; H04W 72/0406

(57) ABSTRACT

Various examples and schemes pertaining to HARQ procedure and PUCCH resource selection in mobile communications are described. An apparatus, such as a user equipment (UE), configures one or more physical uplink control channel (PUCCH) resource sets for each sub-slot of multiple sub-slots within a slot. The apparatus communicates with wireless network by using a hybrid automatic repeat request (HARQ) procedure with the one or more PUCCH resource sets.

### CROSS REFERENCE TO RELATED PATENT APPLICATION(S)

The present disclosure is part of a non-provisional application claiming the priority benefit of U.S. Patent Application No. 62/754,009, filed on 1 Nov. 2018, the content of which being incorporated by reference in its entirety.

### TECHNICAL FIELD

The present disclosure is generally related to mobile communications and, more particularly, to techniques pertaining to hybrid automatic repeat request (HARQ) procedure and physical uplink control channel (PUCCH) resource selection in mobile communications.

### BACKGROUND

Unless otherwise indicated herein, approaches described in this section are not prior art to the claims listed below and are not admitted as prior art by inclusion in this section.

To guarantee latency and reliability for ultra-reliable low-latency communication (URLLC) traffic, it is desirable for HARQ feedback to be channelized onto separate HARQ codebooks. This can be done by defining two HARQ procedures such as a “slow” HARQ procedure (e.g., for enhanced mobile broadband (eMBB)) and a “fast” HARQ procedure (e.g., for URLLC). The different HARQ procedures correspond to separate configurations and assigned PUCCH resources, as well as separate intra-user equipment (UE) multiplexing and prioritization rules. Therefore, there is a need for a mechanism for HARQ procedure selection per downlink transmission. This is also a need for a PUCCH assignment method appropriate for URLLC HARQ feedback. This is further a need for a mechanism for multiple HARQ codebook transmission per port.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

When HARQ acknowledgement (ACK) feedback procedure is based on sub-slots rather than slots, the method of PUCCH assignment may need to be adjusted. A sensible tradeoff may need to be established between scheduling flexibility and signaling overhead. Similar tradeoffs may also need to be considered with dynamic HARQ procedure selection when at least two simultaneously constructed HARQ codebooks (and/or codebook-less HARQ feedback) are available in a given slot/sub-slot.

Under various proposed schemes in accordance with the present disclosure, when HARQ procedure is based on sub-slots rather than slots, start symbol of each PUCCH resource may be indexed with respect to a corresponding sub-slot boundary. Sub-slots may be configured with the same or separate PUCCH resource sets within a slot. PUCCH resources may be allowed to cross sub-slot boundaries but may only be scheduled and transmitted in case they do not overlap with slot boundary or downlink (DL) symbol(s). Additionally, under various proposed schemes in accordance with the present disclosure, selection between HARQ procedures may be achieved with signaling by special value(s) in the PUCCH resource index field of the DCI. The configured special value(s) may at the same time encode index value(s) used in the PUCCH resource selection. Moreover, under various proposed schemes in accordance with the present disclosure, a given sub-slot used for PUCCH transmission may be inferred from the selected PUCCH resource and the N1 user processing timeline, plus any offset signaled by a network to a UE.

In one aspect, a method may involve a processor of an apparatus configuring one or more PUCCH resource sets for each sub-slot of multiple sub-slots within a slot. The method may also involve the processor communicating with a wireless network by using a HARQ procedure with the one or more PUCCH resource sets.

In one aspect, a method may involve a processor of an apparatus receiving a signaling from a wireless network. The method may also involve the processor providing a feedback to the wireless network responsive to the receiving of the signaling by performing a HARQ procedure using at least one sub-slot of multiple sub-slots within a slot, with a start symbol of each PUCCH resource used in the HARQ procedure being indexed with respect to a sub-slot boundary of the at least one sub-slot.

In one aspect, a method may involve a processor of an apparatus receiving a downlink control information (DCI) signaling from a wireless network. The method may also involve the processor selecting one of a plurality of different HARQ procedures based on an indication in an acknowledgement resource index (ARI) field in the DCI signaling. The method may further involve the processor communicating with the wireless network by using the selected HARQ procedure with one or more PUCCH resource sets.

It is noteworthy that, although description provided herein may be in the context of certain radio access technologies, networks and network topologies such as Ethernet, the proposed concepts, schemes and any variation(s)/derivative(s) thereof may be implemented in, for and by other types of radio access technologies, networks and network topologies such as, for example and without limitation, 5th Generation (5G), New Radio (NR), Long-Term Evolution (LTE), LTE-Advanced, LTE-Advanced Pro, narrowband (NB), narrowband Internet of Things (NB-IoT), Wi-Fi and any future-developed networking and communication technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 shows an example scenario in accordance with an implementation of the present disclosure.

FIG. 3 shows an example scenario in accordance with an implementation of the present disclosure.

FIG. 4 shows an example scenario in accordance with an implementation of the present disclosure.

FIG. 5 shows an example scenario in accordance with an implementation of the present disclosure.

FIG. 6 shows an example scenario in accordance with an implementation of the present disclosure.

FIG. 7 shows an example scenario in accordance with an implementation of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

FIG. 11 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to HARQ procedure and PUCCH resource selection in mobile communications. According to the present disclosure, a number of possible solutions may be implemented separately or jointly. That is, although these possible solutions may be described below separately, two or more of these possible solutions may be implemented in one combination or another.

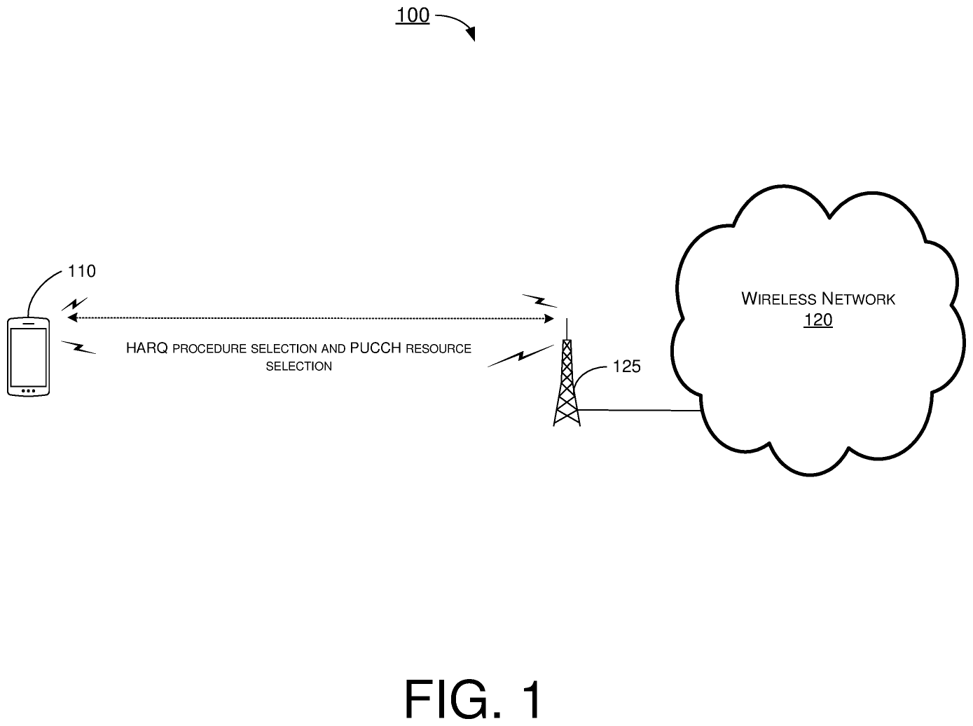

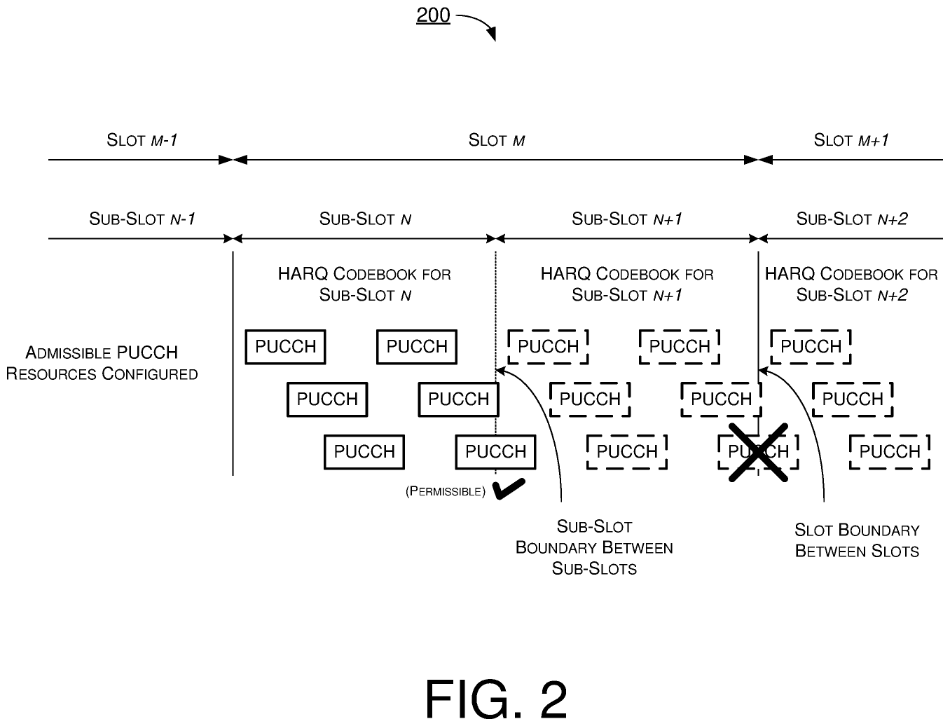

FIG. 1 illustrates an example network environment 100 in which various solutions and schemes in accordance with the present disclosure may be implemented. FIG. 2-FIG. 7 illustrate example scenarios 200, 300, 400, 500, 600 and 700, respectively, in accordance with implementations of the present disclosure. Each of scenarios 200, 300, 400, 500, 600 and 700 may be implemented in network environment 100. The following description of various proposed schemes is provided with reference to FIG. 1-FIG. 7.

Referring to FIG. 1, network environment 100 may involve a UE 110 in wireless communication with a wireless network 120 (e.g., a 5G NR mobile network). UE 110 may initially be in wireless communication with wireless network 120 via a base station or network node 125 (e.g., an eNB, gNB or transmit-receive point (TRP)). In network environment 100, UE 110 and wireless network 120 may implement various schemes pertaining to HARQ procedure and PUCCH resource selection in mobile communications in accordance with the present disclosure, as described herein.

Under release 15 (Rel-15) of the 3^{rd} Generation Partnership Project (3GPP) specification, the 3-bit index in a K1 field of DCI selects a K1 value from a list of 8 elements. This K1 value points to the slot where acknowledgement/negative acknowledgement (ACK/NACK) should be reported for an associated physical downlink shared channel (PDSCH) transmission. All ACK/NACK reports scheduled for the same slot are gathered into a single HARQ codebook, with at most one HARQ codebook produced within a given slot. The HARQ codebook is transmitted over the PUCCH resource that is indicated by the last DCI. The latest DCI reported upon in the same slot would override any previous PUCCH assignments for the slot (and becomes the “last DCI”) unless HARQ codebook content has already been finalized. The HARQ codebook content is finalized a certain number of orthogonal frequency-division multiplexing (OFDM) symbols before the scheduled PUCCH resource, referred to as the “guard gap.” After this point, the PUCCH transmission cannot be overridden, and no more ACK/NACK bits can be added to the same codebook by later DCIs.

Moreover, according to Rel-15 of the 3GPP specification, an ARI field in the last DCI assigns the PUCCH resource within the slot appointed by the K1 field, which selects an element from a preconfigured K1 list. The K1 field is also known as the PDSCH-to-HARQ_feedback in the specification. The K1 list is also known as the dl-DataToUL-ACK in the specification. For uplink transmission, the PUCCH resource set is selected based on the size of the codebook, and size boundaries used in the selection are configurable. From the PUCCH resource set, the ARI bits select the PUCCH resource. In the case of PUCCH resource set 0, the ARI bits and the index of the first control channel element (CCE) carrying the DCI are used together to select the resource.

It is noteworthy that intra-UE multiplexing of HARQ feedback to URLLC traffic with other types of uplink control information (UCI) data and eMBB traffic may be undesirable, as latency and reliability may be compromised. Thus, it would be preferred that a separate HARQ procedure be used for latency-critical traffic. The two HARQ procedures (e.g., a fast HARQ procedure for URLLC and a slow HARQ procedure for eMBB) may provide certain information independently from each other, including: independent HARQ codebooks of independent codebook types, independent PUCCH resource sets and PUCCH selection mechanisms, independent sub-slot definition (which may also vary by service capability server (SCS) or bandwidth part (BWP)), and independent intra-UE multiplexing and prioritization rules with other UCI data. With respect to independent HARQ codebooks of independent codebook types, DL transmission that are excluded from a HARQ codebook due to being handled by the other HARQ procedure may be treated as if the respective HARQ information was reported in a different slot.

For the “fast” HARQ procedure, each slot may be divided into two or more sub-slots, the size of which may be defined to be as large as half of a slot and as small as one OFDM symbol. Dividing a slot into half-slots may provide sufficient granularity for HARQ feedback for even the lowest SCS (e.g., 15 kHz). According to URLLC use case scenarios, two HARQ feedbacks per 1 ms may be sufficient unless fast retransmissions are taking place. There may be complementary techniques to support use cases (e.g., fast retransmissions) where more HARQ codebooks need to be sent than the number of sub-slots within a given slot. When sub-slots are configured, the K1 value may be utilized for selection of a sub-slot for HARQ codebook determination and for PUCCH resource (or the respective starting OFDM symbol).

URLLC typically requires PUCCH resource configuration to minimize the worst-case PUCCH alignment delay. By defining PUCCH resources over a sub-slot shorter than a slot, the density of PUCCH resources over time may be increased while keeping or reducing the amount of DCI bits required for the resource selection. Even for the lowest SCS (e.g., 15 kHz), selecting the size of a sub-slot to be half of a slot may provide sufficient time density of PUCCH resources. Meanwhile, the same choice may allow assuming that one (or maximum two) sub-slot length may be sufficient for the range of feasible PUCCH transmissions following the N1 gap. This assumption may not necessarily hold in an event that the sub-slot length is merely one or two symbols.

With respect to dynamic HARQ procedure indication per DL transmission, a number of options may be possible. For instance, a search space configuration may indicate a selected HARQ procedure. However, this may introduce new constraints for scheduling and may have impact on radio resource control (RRC) configuration. Another option may be to new DCI bits to indicate the selected HARQ procedure. However, existing DCI format(s) may be modified, thereby reducing robustness by increasing code rate. A different option may be to use an existing DCI field to indicate the selected HARQ procedure. For instance, one or more reserved values (e.g., K1 list) in an existing DCI field may be utilized, and the reserved value(s) may be made optional by introducing appropriate RRC configuration. The downsides may include some (tolerable) loss of flexibility and impact on RRC configuration.

Under a proposed scheme in accordance with the present disclosure with respect to PUCCH assignment within a sub-slot, PUCCH resources in a HARQ procedure may be configured on a sub-slot basis. Referring to FIG. 2, for a certain HARQ procedure (e.g., “fast” HARQ procedure), RRC configurable PUCCH resource set(s) may be defined for each sub-slot of multiple sub-slots within each slot of a plurality of slots. In scenario 200, slot m is shown to have two sub-slots, namely sub-slot n and sub-slot n+1, with sub-slot n being adjacent to sub-slot n−1 of slot m−1 and with sub-slot n+1 being adjacent to sub-slot n+2 of slot m+1.

Under the proposed scheme, the start symbol of a PUCCH resource may be indexed with respect to the sub-slot boundary of the respective sub-slot in which the PUCCH resource is allocated or otherwise assigned. For instance, each PUCCH resource may have a starting symbol index (StartingSymbolIndex), which may be 0 for the OFDM symbol starting on a sub-slot boundary and incremented thereafter. Under the proposed scheme, a same PUCCH configuration or different PUCCH configurations may be applied to multiple sub-slots of each slot. For instance, the same PUCCH configuration may be applied to each sub-slot within a given slot. Alternatively, separate and different PUCCH configurations may be applied to the multiple sub-slots within a given slot. Under the proposed scheme, configured PUCCH resources may be allowed to cross a sub-slot boundary between two adjacent sub-slots within the same slot, as shown in FIG. 2. That is, scheduling and transmission of configured PUCCH resources may be allowed when there is no overlap with a slot boundary or any DL symbols.

Under the proposed scheme, separate PUCCH resource sets may be defined for the “fast” HARQ procedure (e.g., for URLLC) and “slow” HARQ procedure (e.g., for eMBB). The PUCCH resource sets may be selected based on a codebook size, and size boundaries may be configurable between adjacent sets (e.g., between sets 1 and 2, and between sets 2 and 3). Under the proposed scheme, a 3-bit ARI field (and the starting symbol of the first CCE in the case of set 0) may be utilized to select the PUCCH resource within a given PUCCH resource set. Advantageously, as the same amount of resource configurations may be supported for a single sub-slot separately from the configurations of the other HARQ procedure, the time density of resources may be increased and PUCCH alignment delay may be greatly decreased.

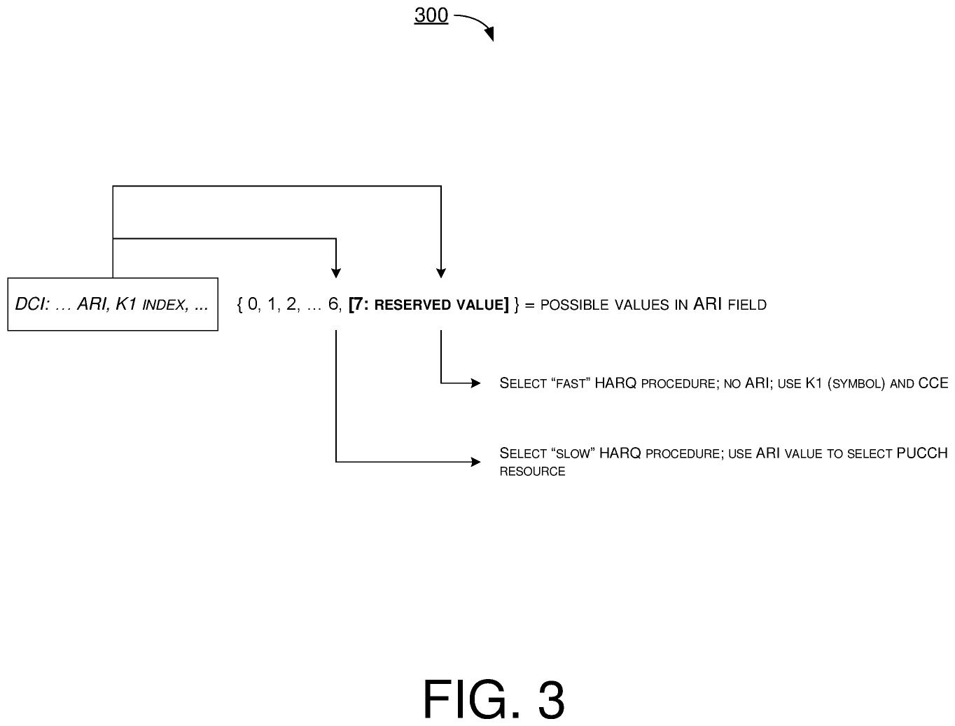

Under a proposed scheme in accordance with the present disclosure with respect to indication of HARQ procedure, selection of a HARQ procedure from a plurality of different HARQ procedures (e.g., “fast” and “slow” HARQ procedures) may be indicated using reserved value(s) in the ARI field in DCI. Under the proposed scheme, a value in the ARI field (e.g., ARI=6 or ARI=7) may be reserved for selection of the “fast” HARQ procedure, and ARI_fast=ARI-6 when the “fast” HARQ procedure is selected. Referring to FIG. 3, a value of 7 in the ARI field may be reserved for selection of the “fast” HARQ procedure. Under the proposed scheme, PUCCH resource selection of the “slow” HARQ procedure may be adjusted to accommodate the reduced ARI range. Under the proposed scheme, PUCCH resource selection for the “fast” HARQ procedure may be based on one or more of the following: a value of a HARQ feedback timing indicator (K1), a size of a HARQ codebook, and an OFDM symbol index of a first CCE carrying a last DCI signaling. Alternatively, multiple reserved values may be defined for the ARI field for selection of the “fast” HARQ procedure while also provide side information regarding PUCCH resource selection.

Under the proposed scheme, selection of HARQ procedure using the ARI field may be enabled by RRC configuration separately per each SCS and DL DCI type. With respect to the “fast” HARQ procedure, sub-slots for HARQ codebook determination may be defined as symbols. Under the proposed scheme, at most one HARQ codebook may be determined per symbol (e.g., appointed by K1 value), and vice versa, with each symbol mapped to a separate HARQ codebook which is to be transmitted on a PUCCH resource starting in that OFDM symbol. Under the proposed scheme, HARQ codebook size may be utilized to select the PUCCH resource set. Within each PUCCH resource set, the scheduled PUCCH may be selected by the index of the first CCE carrying the last DCI or a combination of ARI_fast and the index of the first CCE carrying the last DCI.

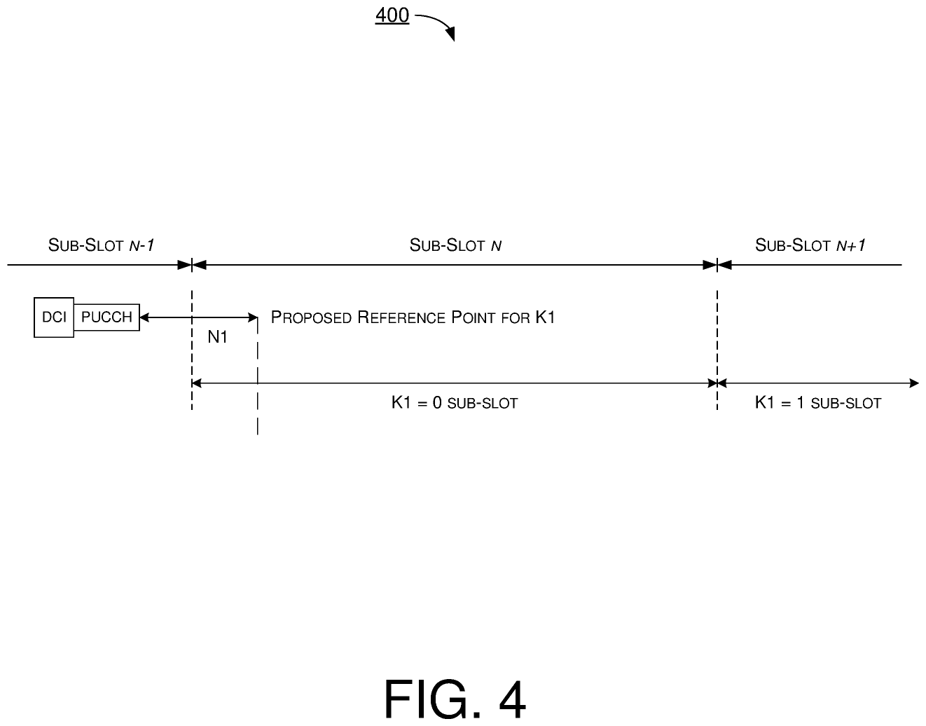

Under a proposed scheme in accordance with the present disclosure with respect to reference point for K1, the first OFDM symbol after the N1 gap may be used as a reference point for PUCCH assignment, with the K1 value representative of a count of sub-slot boundaries between the reference point and PUCCH. Referring to FIG. 4, K1=0 may indicate the same sub-slot as the reference point, K1=1 may indicate the first sub-slot after the one containing the reference point, and so on for K1=2, 3 and other values.

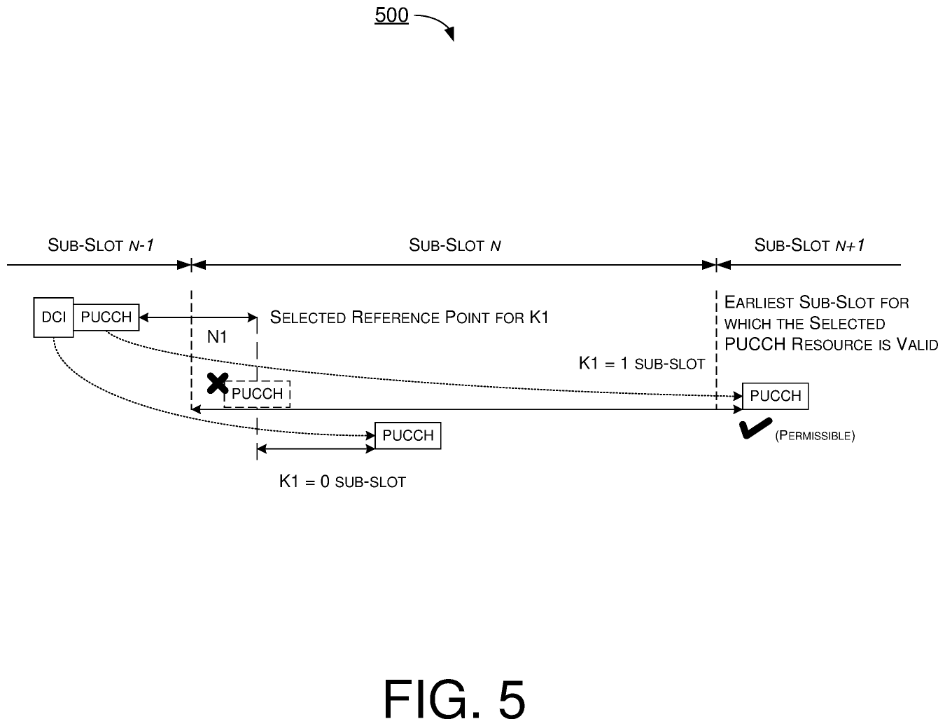

Under a proposed scheme in accordance with the present disclosure with respect to inferred sub-slot without side information, a reference point for K1 may be selected by any suitable method. Referring to FIG. 5, X may denote the number of sub-slot boundaries between the end of N1 and the selected reference point. For instance, the end of N1 may be the reference point (X=0). Alternatively, according to Rel-15 of the 3GPP specification, end of PDSCH (X=1) may be the reference point. Under the proposed scheme, in the absence of K1 indication, K1=X+1 may be inferred in an event that a combination of ARI, CCE and codebook size selects a PUCCH resource that starts before the reference point; otherwise K1=X may be inferred.

Under the proposed scheme, complementary side information may be provided to infer K1. For instance, the side information may be an RRC configuration (e.g., increment_K1_by_1_subslot={Yes|No}). Alternatively, the side information may be deduced from a DCI field that schedules the HARQ. Under the proposed scheme, in an event that a combination of ARI, CCE and codebook size selects a PUCCH resource that starts before the reference point, then K1=X+1+S may be inferred; otherwise K1=X+S may be inferred. Here, the value of S may be the number of sub-slots indicated for the offset by the side information.

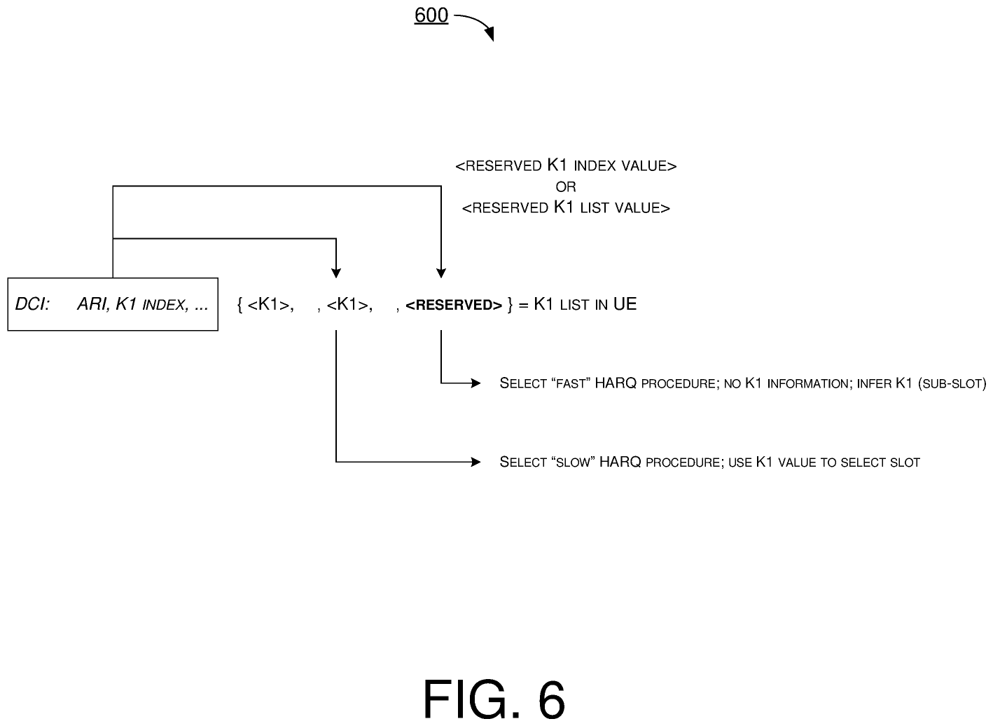

Under a proposed scheme in accordance with the present disclosure with respect to indication of HARQ procedure, reserved value(s) in K1 index or K1 list may be utilized to indicate selection of HARQ procedure. Referring to FIG. 6, the “slow” HARQ procedure may be provisioned with a K1 list (e.g., with a conveniently selected representable value) while the “fast” HARQ procedure may not be. Under the proposed scheme, the K1 field in DCI may be used as a pointer to the (single) K1 list belonging to the “slow” HARQ procedure. In an event that the K1 list contains the reserved value, and that element is selected by the DCI, then the “fast” HARQ procedure may be used without information on K1, which may need to be inferred. Otherwise, the “slow” HARQ procedure may be selected and K1 value may be used in a conventional way. Alternatively, a reserved index value in the K1 index field may be used as an enabler for HARQ procedure selection.

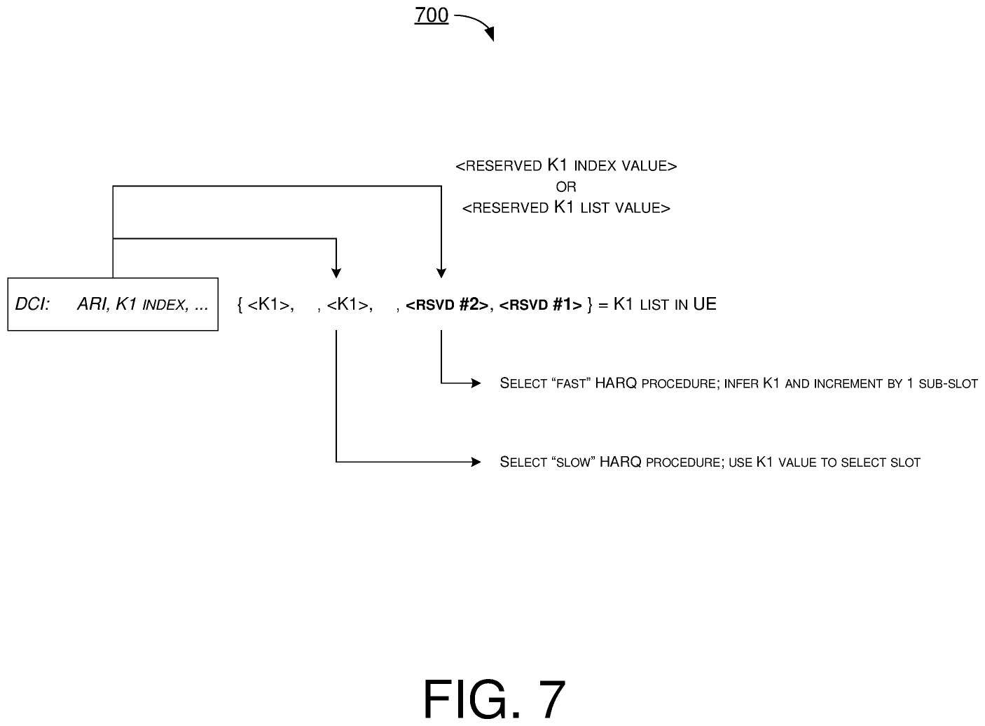

Referring to FIG. 7, the proposed scheme may be extended to two or more reserved values. For instance, a first reserved value (denoted as “rsvd #1” in FIG. 7) may be utilized to select the “fast” HARQ procedure, and a second reserved value (denoted as “rsvd #2” in FIG. 7) may be utilized to select the “fast” HARQ procedure and add an extra sub-slot to an inferred K1 offset. Alternatively, the second reserved value (rsvd #2) may be utilized to select the “fast” HARQ procedure and apply an offset to the ARI value, so that it can address a PUCCH resource within an increased PUCCH resource set. Still alternatively, one or more reserved index values in the K1 index field may be utilized to perform the selection. Under the proposed scheme, once the PUCCH resource is selected (which requires HARQ information size) then sub-slot may be inferred as the earliest sub-slot that abides the N1 user processing timeline (plus any offset signaled by network node 125 to UE 110). The above-described PUCCH timing may be combined with the selectin of HARQ procedure by configuring special values to be used with the existing DCI field K1 index or the RRC-configured K1 set.

It is noteworthy that the proposed scheme may be made optional and enabled using RRC configurations. The reserved values may be predefined (e.g., by constants or rules) or explicitly configured using RRC configurations. For instance, in an event that reserved values are configured explicitly then the proposed scheme may be implemented with predefined K1 list as well, as with DCI_1_0. The number of reserved values, and the reserved values themselves, may be configured separately for each SCS or BWP (as well as each DL DCI type, as needed). The reserved value(s) may be applied either in the K1 index field or in the K1 list. For illustrative purposes and without limiting the scope of the present disclosure, an example implementation is described below.

As an example, selective configuration of the number of reserved values per SCS or BWP may be implemented as follows:
Number_of_enabled_reserved_values_for_dl-DataToUL-ACK_SCS15 kHz=integer in {0, 1, . . . }
Number_of_enabled_reserved_values_for_dl-DataToUL-ACK_SCS30 kHz=integer in {0, 1, . . . }

In this example, encoding may be as follows:
0: disable dynamic selection of “fast” HARA procedure;
1, 2, . . . : define 1, 2, . . . number of reserved values according either to some rule or explicit configuration

In this example, possible rules for reserved value selection may include:
1. Start from the highest representable number (optionally, only use odd numbers or only use even numbers to maintain the maximum range); and
2. Last elements in the list (equivalent to fixing K1 index=7 as the first reserved value).

Alternatively, in this example, explicit configuration may be used for the reserved values (per SCS or BWP). For example:
Reserved_values_for_dl-DataToUL-ACKk_SCS15 kHz=vector of length 0, 1, 2, . . . (length configured above)

As another example, selective configuration of the number of reserved values per SCS or BWP may be implemented as follows:
Number_of_enabled_reserved_values_for_PDSCH-to-HARQ_feedback SCS15 kHz=integer in {0, 1, . . . }
Number_of_enabled_reserved_values_for_PDSCH-to-HARQ_feedback SCS30 kHz=integer in {0, 1, . . . }

In this example, encoding may be as follows:
0: disable dynamic selection of “fast” HARA procedure;
1, 2, . . . : define 1, 2, . . . number of reserved values according to explicit configuration

In this example, the explicit configuration for the reserved values (per SCS or BWP) may be as follows:
Reserved_values_for_PDSCH-to-HARQ_feedback SCS15 kHz=vector of length 0, 1, 2, . . . (length configured above)

The above configuration may be applied with selected DL DCI type(s) only. Alternatively, separate independent configurability of above parameters may be supported for each DL DCI type.

As yet another example, the selection between multiple reserved values may provide side information for the PUCCH resource selection complementing the ARI value. For instance, two reserved values (e.g., A and B) may be configured. In an event that A or B is indicated by the DCI, then the “fast” HARQ procedure may be selected plus one or more actions. One action may be that, in an event that A is indicated, bit “0” may be prepended to ARI. Another action may be that, in an event that B is indicated, bit “1” may be prepended to ARI. Yet another action may involve using the incremented ARI value (and CCE) to select the PUCCH resource from a large set of PUCCH resources.

### Illustrative Implementations

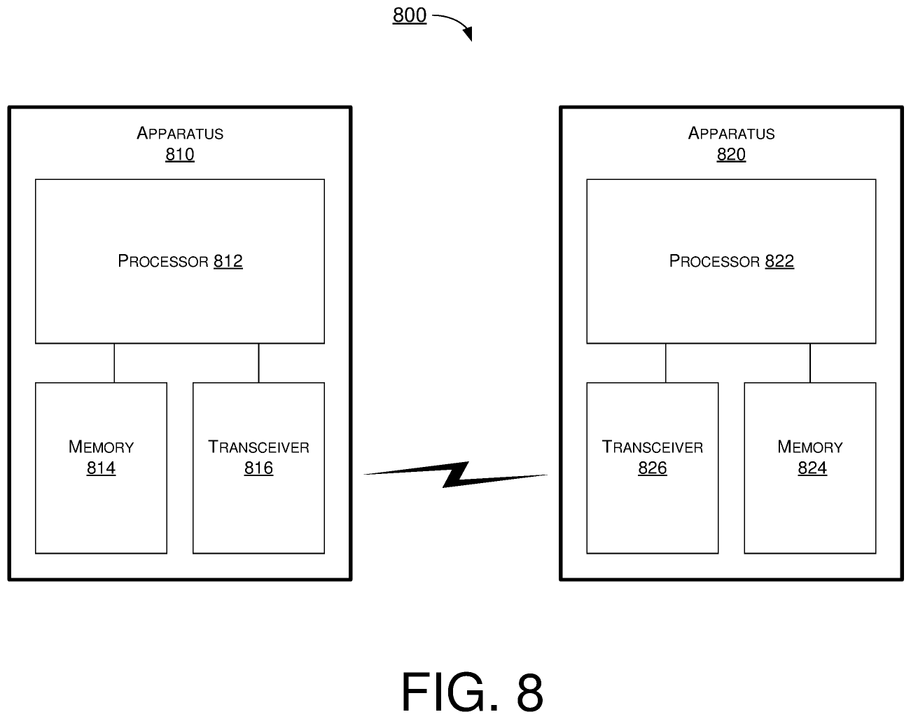

FIG. 8 illustrates an example communication system 800 having an example apparatus 810 and an example apparatus 820 in accordance with an implementation of the present disclosure. Each of apparatus 810 and apparatus 820 may perform various functions to implement schemes, techniques, processes and methods described herein pertaining to HARQ procedure and PUCCH resource selection in mobile communications, including various schemes described above as well as processes described below.

Each of apparatus 810 and apparatus 820 may be a part of an electronic apparatus, which may be a UE such as a vehicle, a portable or mobile apparatus, a wearable apparatus, a wireless communication apparatus or a computing apparatus. For instance, each of apparatus 810 and apparatus 820 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 810 and apparatus 820 may also be a part of a machine type apparatus, which may be an IoT or NB-IoT apparatus such as an immobile or a stationary apparatus, a home apparatus, a wire communication apparatus or a computing apparatus. For instance, each of apparatus 810 and apparatus 820 may be implemented in a smart thermostat, a smart fridge, a smart door lock, a wireless speaker or a home control center. Alternatively, each of apparatus 810 and apparatus 820 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 810 and apparatus 820 may include at least some of those components shown in FIG. 8 such as a processor 812 and a processor 822, respectively. Each of apparatus 810 and apparatus 820 may further include one or more other components not pertinent to the proposed scheme of the present disclosure (e.g., internal power supply, display device and/or user interface device), and, thus, such component(s) of each of apparatus 810 and apparatus 820 are neither shown in FIG. 8 nor described below in the interest of simplicity and brevity.

In some implementations, at least one of apparatus 810 and apparatus 820 may be a part of an electronic apparatus, which may be a vehicle, a roadside unit (RSU), network node or base station (e.g., eNB, gNB or TRP), a small cell, a router or a gateway. For instance, at least one of apparatus 810 and apparatus 820 may be implemented in a vehicle in a vehicle-to-vehicle (V2V) or vehicle-to-everything (V2X) network, an eNodeB in an LTE, LTE-Advanced or LTE-Advanced Pro network or in a gNB in a 5G, NR, IoT or NB-IoT network. Alternatively, at least one of apparatus 810 and apparatus 820 may be implemented in the form of one or more IC chips such as, for example and without limitation, one or more single-core processors, one or more multi-core processors, or one or more CISC or RISC processors.

In one aspect, each of processor 812 and processor 822 may be implemented in the form of one or more single-core processors, one or more multi-core processors, or one or more CISC or RISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including HARQ procedure and PUCCH resource selection in mobile communications in accordance with various implementations of the present disclosure.

In some implementations, apparatus 810 may also include a wireless transceiver 816 coupled to processor 812 and capable of wirelessly transmitting and receiving data over a wireless link (e.g., a 3GPP connection or a non-3GPP connection). In some implementations, apparatus 810 may further include a memory 814 coupled to processor 812 and capable of being accessed by processor 812 and storing data therein. In some implementations, apparatus 820 may also include a wireless transceiver 826 coupled to processor 822 and capable of wirelessly transmitting and receiving data over a wireless link (e.g., a 3GPP connection or a non-3GPP connection). In some implementations, apparatus 820 may further include a memory 824 coupled to processor 822 and capable of being accessed by processor 822 and storing data therein. Accordingly, apparatus 810 and apparatus 820 may wirelessly communicate with each other via transceiver 816 and transceiver 826, respectively.

To aid better understanding, the following description of the operations, functionalities and capabilities of each of apparatus 810 and apparatus 820 is provided in the context of an NR communication environment in which apparatus 810 is implemented in or as a wireless communication device, a communication apparatus, a UE or an IoT device (e.g., UE 110) and apparatus 820 is implemented in or as a base station or network node (e.g., network node 125).

In one aspect of HARQ procedure and PUCCH resource selection in mobile communications in accordance with the present disclosure, processor 812 of apparatus 810 may configure one or more PUCCH resource sets for each sub-slot of multiple sub-slots within a slot. Additionally, processor 812 may communicate, via transceiver 816, with a wireless network (e.g., wireless network 120 via apparatus 820 as network node 125) by using a HARQ procedure with the one or more PUCCH resource sets.

In some implementations, in configuring the one or more PUCCH resource sets for each sub-slot of the multiple sub-slots within the slot, processor 812 may apply a same PUCCH configuration to each sub-slot of the multiple sub-slots within the slot.

In some implementations, in configuring the one or more PUCCH resource sets for each sub-slot of the multiple sub-slots within the slot, processor 812 may perform certain operations. For instance, processor 812 may apply a first PUCCH configuration to a first sub-slot of the multiple sub-slots. Additionally, processor 812 may apply a second PUCCH configuration to a second sub-slot of the multiple sub-slots. The first PUCCH configuration and the second PUCCH configuration may be different.

In some implementations, in configuring the one or more PUCCH resource sets for each sub-slot of the multiple sub-slots within the slot, processor 812 may configure the one or more PUCCH resource sets for each sub-slot of the multiple sub-slots such that one of the one PUCCH resource of the one or more PUCCH resource sets crosses a sub-slot boundary between two adjacent sub-slots within the slot.

In some implementations, in configuring the one or more PUCCH resource sets for each sub-slot of the multiple sub-slots within the slot, processor 812 may configure the one or more PUCCH resource sets for each sub-slot of the multiple sub-slots within each of one or more slots of a plurality of slots such that no PUCCH resource of the one or more PUCCH resource sets overlaps a DL symbol or a slot boundary between two adjacent slots of the plurality of slots.

In some implementations, in configuring the one or more PUCCH resource sets for each sub-slot of the multiple sub-slots within the slot, processor 812 may perform certain operations. For instance, processor 812 may receive a signaling from the wireless network. Moreover, processor 812 may configure the one or more PUCCH resource sets for each sub-slot of the multiple sub-slots within the slot based on the signaling. In some implementations, the signaling may include an RRC signaling.

In some implementations, in communicating by using the wireless network in the HARQ procedure with the one or more PUCCH resource sets, processor 812 may transmit symbols of the one or more PUCCH resource sets such that each of the symbols is indexed with reference to a sub-slot boundary of a respective sub-slot of the multiple sub-slots.

In some implementations, in communicating by using the wireless network in the HARQ procedure with the one or more PUCCH resource sets, processor 812 may perform certain operations. For instance, processor 812 may select one of a plurality of different HARQ procedures based on an indication in an ARI field in a DCI signaling. Moreover, processor 812 may communicate with the wireless network using the selected HARQ procedure.

In some implementations, in selecting based on the indication in the ARI field, processor 812 may select a fast HARQ procedure from the plurality of different HARQ procedures for ultra-reliable low-latency communication (URLLC) based on a specific value in the ARI field that is reserved to indicate selection of the fast HARQ procedure. In such cases, in configuring the one or more PUCCH resource sets, processor 812 may select a PUCCH resource of the one or more PUCCH resource sets for the fast HARQ procedure based on a value of a HARQ feedback timing indicator (K1), a size of a HARQ codebook, or an OFDM symbol index of a first CCE carrying a last DCI signaling.

Alternatively, in selecting based on the indication in the ARI field, processor 812 may select a second HARQ procedure from the plurality of different HARQ procedures for enhanced mobile broadband (eMBB). In such cases, in configuring the one or more PUCCH resource sets, processor 812 may select a PUCCH resource of the one or more PUCCH resource sets for the slow HARQ procedure based on a value in the ARI field.

In another aspect of HARQ procedure and PUCCH resource selection in mobile communications in accordance with the present disclosure, processor 812 of apparatus 810 may receive, via transceiver 816, a signaling from a wireless network (e.g., wireless network 120 via apparatus 820 as network node 125). Moreover, processor 812 may provide, via transceiver 816, a feedback to the wireless network responsive to the receiving of the signaling by performing a HARQ procedure using at least one sub-slot of multiple sub-slots within a slot, with a start symbol of each PUCCH resource used in the HARQ procedure being indexed with respect to a sub-slot boundary of the at least one sub-slot.

In some implementations, in providing the feedback to the wireless network by performing the HARQ procedure, processor 812 may configure one or more PUCCH resource sets for each sub-slot of the multiple sub-slots within the slot.

In some implementations, in configuring the one or more PUCCH resource sets for each sub-slot of the multiple sub-slots within the slot, processor 812 may apply a same PUCCH configuration to each sub-slot of the multiple sub-slots within the slot.

In some implementations, in configuring the one or more PUCCH resource sets for each sub-slot of the multiple sub-slots within the slot, processor 812 may perform certain operations. For instance, processor 812 may apply a first PUCCH configuration to a first sub-slot of the multiple sub-slots. Moreover, processor 812 may apply a second PUCCH configuration to a second sub-slot of the multiple sub-slots. The first PUCCH configuration and the second PUCCH configuration may be different.

In some implementations, in configuring the one or more PUCCH resource sets for each sub-slot of the multiple sub-slots within the slot, processor 812 may configure the one or more PUCCH resource sets for each sub-slot of the multiple sub-slots such that one of the one PUCCH resource of the one or more PUCCH resource sets crosses a sub-slot boundary between two adjacent sub-slots within the slot.

In some implementations, in configuring the one or more PUCCH resource sets for each sub-slot of the multiple sub-slots within the slot, processor 812 may configure the one or more PUCCH resource sets for each sub-slot of the multiple sub-slots within each of one or more slots of a plurality of slots such that no PUCCH resource of the one or more PUCCH resource sets overlaps a DL symbol or a slot boundary between two adjacent slots of the plurality of slots.

In some implementations, in receiving the signaling, process 1000 may involve processor 812 may receive an RRC signaling. Moreover, in configuring the one or more PUCCH resource sets for each sub-slot of the multiple sub-slots within the slot, processor 812 may configure the one or more PUCCH resource sets for each sub-slot of the multiple sub-slots within the slot based on the RRC signaling.

In yet another aspect of HARQ procedure and PUCCH resource selection in mobile communications in accordance with the present disclosure, processor 812 of apparatus 810 may receive, via transceiver 816, a DCI signaling from a wireless network (e.g., wireless network 120 via apparatus 820 as network node 125). Additionally, processor 812 may select one of a plurality of different HARQ procedures based on an indication in an ARI field in the DCI signaling. Moreover, processor 812 may communicate, via transceiver 816, with the wireless network via apparatus 820 by using the selected HARQ procedure with one or more PUCCH resource sets.

In some implementations, in selecting based on the indication in the ARI field, processor 812 may select a fast HARQ procedure from the plurality of different HARQ procedures for URLLC based on a specific value in an ARI field that is reserved to indicate selection of the fast HARQ procedure. In such cases, in communicating by using the selected HARQ procedure with the one or more PUCCH resource sets, processor 812 may select a PUCCH resource of the one or more PUCCH resource sets for the fast HARQ procedure based on a value of a HARQ feedback timing indicator (K1), a size of a HARQ codebook, or an OFDM symbol index of a first CCE carrying a last DCI signaling.

Alternatively, in selecting based on the indication in the ARI field, processor 812 may select a second HARQ procedure from the plurality of different HARQ procedures for eMBB. In such cases, in communicating by using the selected HARQ procedure with the one or more PUCCH resource sets, processor 812 may select a PUCCH resource of the one or more PUCCH resource sets for the slow HARQ procedure based on a value in the ARI field. Illustrative Processes

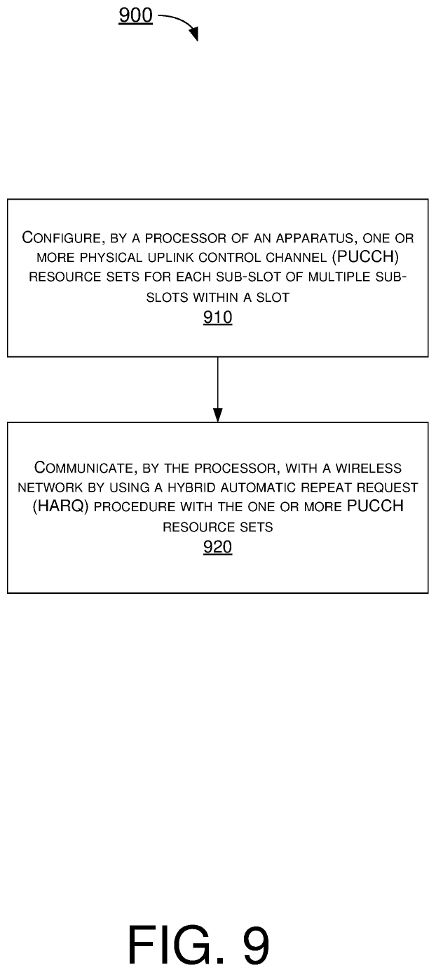

FIG. 9 illustrates an example process 900 in accordance with an implementation of the present disclosure. Process 900 may be an example implementation of the proposed schemes described above with respect to HARQ procedure and PUCCH resource selection in mobile communications in accordance with the present disclosure. Process 900 may represent an aspect of implementation of features of apparatus 810 and apparatus 820. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks of process 900 may executed in the order shown in FIG. 9 or, alternatively, in a different order. Process 900 may also be repeated partially or entirely. Process 900 may be implemented by apparatus 810, apparatus 820 and/or any suitable wireless communication device, UE, RSU, base station or machine type devices. Solely for illustrative purposes and without limitation, process 900 is described below in the context of apparatus 810 as UE 110 and apparatus 820 as network node 125. Process 900 may begin at block 910.

At 910, process 900 may involve processor 812 of apparatus 810 configuring one or more PUCCH resource sets for each sub-slot of multiple sub-slots within a slot. Process 900 may proceed from 910 to 920.

At 920, process 900 may involve processor 812 communicating, via transceiver 816, with a wireless network (e.g., wireless network 120 via apparatus 820 as network node 125) by using a HARQ procedure with the one or more PUCCH resource sets.

In some implementations, in configuring the one or more PUCCH resource sets for each sub-slot of the multiple sub-slots within the slot, process 900 may involve processor 812 applying a same PUCCH configuration to each sub-slot of the multiple sub-slots within the slot.

In some implementations, in configuring the one or more PUCCH resource sets for each sub-slot of the multiple sub-slots within the slot, process 900 may involve processor 812 performing certain operations. For instance, process 900 may involve processor 812 applying a first PUCCH configuration to a first sub-slot of the multiple sub-slots. Additionally, process 900 may involve processor 812 applying a second PUCCH configuration to a second sub-slot of the multiple sub-slots. The first PUCCH configuration and the second PUCCH configuration may be different.

In some implementations, in configuring the one or more PUCCH resource sets for each sub-slot of the multiple sub-slots within the slot, process 900 may involve processor 812 configuring the one or more PUCCH resource sets for each sub-slot of the multiple sub-slots such that one of the one PUCCH resource of the one or more PUCCH resource sets crosses a sub-slot boundary between two adjacent sub-slots within the slot.

In some implementations, in configuring the one or more PUCCH resource sets for each sub-slot of the multiple sub-slots within the slot, process 900 may involve processor 812 configuring the one or more PUCCH resource sets for each sub-slot of the multiple sub-slots within each of one or more slots of a plurality of slots such that no PUCCH resource of the one or more PUCCH resource sets overlaps a DL symbol or a slot boundary between two adjacent slots of the plurality of slots.

In some implementations, in configuring the one or more PUCCH resource sets for each sub-slot of the multiple sub-slots within the slot, process 900 may involve processor 812 performing certain operations. For instance, process 900 may involve processor 812 receiving a signaling from the wireless network. Moreover, process 900 may involve processor 812 configuring the one or more PUCCH resource sets for each sub-slot of the multiple sub-slots within the slot based on the signaling. In some implementations, the signaling may include an RRC signaling.

In some implementations, in communicating by using the wireless network in the HARQ procedure with the one or more PUCCH resource sets, process 900 may involve processor 812 transmitting symbols of the one or more PUCCH resource sets such that each of the symbols is indexed with reference to a sub-slot boundary of a respective sub-slot of the multiple sub-slots.

In some implementations, in communicating by using the wireless network in the HARQ procedure with the one or more PUCCH resource sets, process 900 may involve processor 812 performing certain operations. For instance, process 900 may involve processor 812 selecting one of a plurality of different HARQ procedures based on an indication in an ARI field in a DCI signaling. Moreover, process 900 may involve processor 812 communicating with the wireless network using the selected HARQ procedure.

In some implementations, in selecting based on the indication in the ARI field, process 900 may involve processor 812 selecting a fast HARQ procedure from the plurality of different HARQ procedures for ultra-reliable low-latency communication (URLLC) based on a specific value in the ARI field that is reserved to indicate selection of the fast HARQ procedure. In such cases, in configuring the one or more PUCCH resource sets, process 900 may involve processor 812 selecting a PUCCH resource of the one or more PUCCH resource sets for the fast HARQ procedure based on a value of a HARQ feedback timing indicator (K1), a size of a HARQ codebook, or an OFDM symbol index of a first CCE carrying a last DCI signaling.

Alternatively, in selecting based on the indication in the ARI field, process 900 may involve processor 812 selecting a second HARQ procedure from the plurality of different HARQ procedures for enhanced mobile broadband (eMBB). In such cases, in configuring the one or more PUCCH resource sets, process 900 may involve processor 812 selecting a PUCCH resource of the one or more PUCCH resource sets for the slow HARQ procedure based on a value in the ARI field.

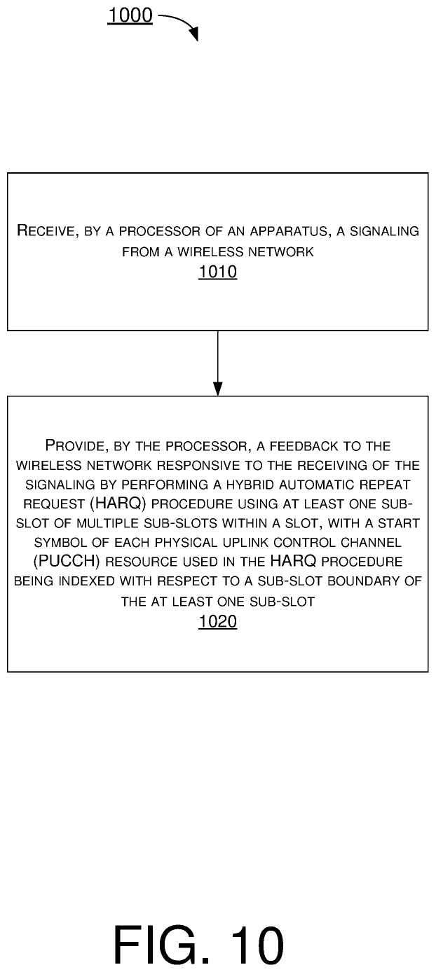

FIG. 10 illustrates an example process 1000 in accordance with an implementation of the present disclosure. Process 1000 may be an example implementation of the proposed schemes described above with respect to HARQ procedure and PUCCH resource selection in mobile communications in accordance with the present disclosure. Process 1000 may represent an aspect of implementation of features of apparatus 810 and apparatus 820. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks of process 1000 may executed in the order shown in FIG. 10 or, alternatively, in a different order. Process 1000 may also be repeated partially or entirely. Process 1000 may be implemented by apparatus 810, apparatus 820 and/or any suitable wireless communication device, UE, RSU, base station or machine type devices. Solely for illustrative purposes and without limitation, process 1000 is described below in the context of apparatus 810 as UE 110 and apparatus 820 as network node 125. Process 1000 may begin at block 1010.

At 1010, process 1000 may involve processor 812 of apparatus 810 receiving, via transceiver 816, a signaling from a wireless network (e.g., wireless network 120 via apparatus 820 as network node 125). Process 1000 may proceed from 1010 to 1020.

At 1020, process 1000 may involve processor 812 providing, via transceiver 816, a feedback to the wireless network responsive to the receiving of the signaling by performing a HARQ procedure using at least one sub-slot of multiple sub-slots within a slot, with a start symbol of each PUCCH resource used in the HARQ procedure being indexed with respect to a sub-slot boundary of the at least one sub-slot.

In some implementations, in providing the feedback to the wireless network by performing the HARQ procedure, process 1000 may involve processor 812 configuring one or more PUCCH resource sets for each sub-slot of the multiple sub-slots within the slot.

In some implementations, in configuring the one or more PUCCH resource sets for each sub-slot of the multiple sub-slots within the slot, process 1000 may involve processor 812 applying a same PUCCH configuration to each sub-slot of the multiple sub-slots within the slot.

In some implementations, in configuring the one or more PUCCH resource sets for each sub-slot of the multiple sub-slots within the slot, process 1000 may involve processor 812 performing certain operations. For instance, process 1000 may involve processor 812 applying a first PUCCH configuration to a first sub-slot of the multiple sub-slots. Moreover, process 1000 may involve processor 812 applying a second PUCCH configuration to a second sub-slot of the multiple sub-slots. The first PUCCH configuration and the second PUCCH configuration may be different.

In some implementations, in configuring the one or more PUCCH resource sets for each sub-slot of the multiple sub-slots within the slot, process 1000 may involve processor 812 configuring the one or more PUCCH resource sets for each sub-slot of the multiple sub-slots such that one of the one PUCCH resource of the one or more PUCCH resource sets crosses a sub-slot boundary between two adjacent sub-slots within the slot.

In some implementations, in configuring the one or more PUCCH resource sets for each sub-slot of the multiple sub-slots within the slot, process 1000 may involve processor 812 configuring the one or more PUCCH resource sets for each sub-slot of the multiple sub-slots within each of one or more slots of a plurality of slots such that no PUCCH resource of the one or more PUCCH resource sets overlaps a DL symbol or a slot boundary between two adjacent slots of the plurality of slots.

In some implementations, in receiving the signaling, process 1000 may involve processor 812 receiving an RRC signaling. Moreover, in configuring the one or more PUCCH resource sets for each sub-slot of the multiple sub-slots within the slot, process 1000 may involve processor 812 configuring the one or more PUCCH resource sets for each sub-slot of the multiple sub-slots within the slot based on the RRC signaling.

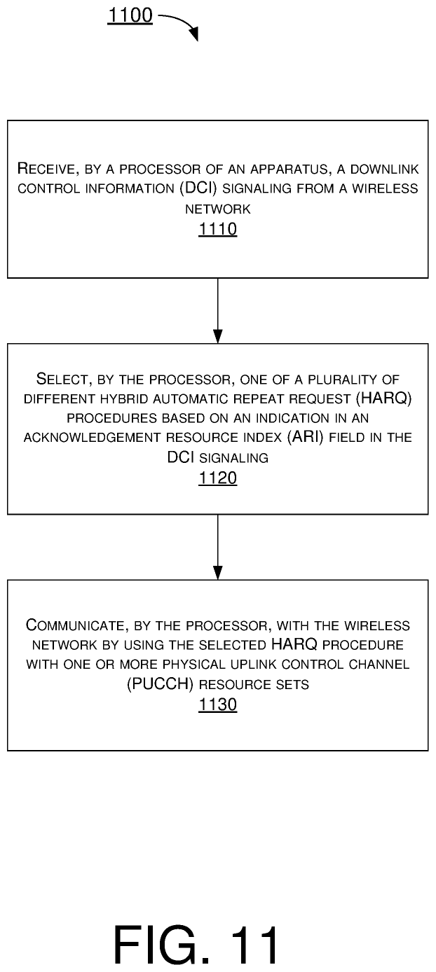

FIG. 11 illustrates an example process 1100 in accordance with an implementation of the present disclosure. Process 1100 may be an example implementation of the proposed schemes described above with respect to HARQ procedure and PUCCH resource selection in mobile communications in accordance with the present disclosure. Process 1100 may represent an aspect of implementation of features of apparatus 810 and apparatus 820. Process 1100 may include one or more operations, actions, or functions as illustrated by one or more of blocks 1110, 1120 and 1130. Although illustrated as discrete blocks, various blocks of process 1100 may be divided into additional blocks, combined into fewer blocks, or eliminated, depending on the desired implementation. Moreover, the blocks of process 1100 may executed in the order shown in FIG. 11 or, alternatively, in a different order. Process 1100 may also be repeated partially or entirely. Process 1100 may be implemented by apparatus 810, apparatus 820 and/or any suitable wireless communication device, UE, RSU, base station or machine type devices. Solely for illustrative purposes and without limitation, process 1100 is described below in the context of apparatus 810 as UE 110 and apparatus 820 as network node 125. Process 1100 may begin at block 1110.

At 1110, process 1100 may involve processor 812 of apparatus 810 receiving, via transceiver 816, a DCI signaling from a wireless network (e.g., wireless network 120 via apparatus 820 as network node 125). Process 1100 may proceed from 1110 to 1120.

At 1120, process 1100 may involve processor 812 selecting one of a plurality of different HARQ procedures based on an indication in an ARI field in the DCI signaling. Process 1100 may proceed from 1120 to 1130.

At 1130, process 1100 may involve processor 812 communicating, via transceiver 816, with the wireless network via apparatus 820 by using the selected HARQ procedure with one or more PUCCH resource sets.

In some implementations, in selecting based on the indication in the ARI field, process 1100 may involve processor 812 selecting a fast HARQ procedure from the plurality of different HARQ procedures for URLLC based on a specific value in an ARI field that is reserved to indicate selection of the fast HARQ procedure. In such cases, in communicating by using the selected HARQ procedure with the one or more PUCCH resource sets, process 1100 may involve processor 812 selecting a PUCCH resource of the one or more PUCCH resource sets for the fast HARQ procedure based on a value of a HARQ feedback timing indicator (K1), a size of a HARQ codebook, or an OFDM symbol index of a first CCE carrying a last DCI signaling.

Alternatively, in selecting based on the indication in the ARI field, process 1100 may involve processor 812 selecting a second HARQ procedure from the plurality of different HARQ procedures for eMBB. In such cases, in communicating by using the selected HARQ procedure with the one or more PUCCH resource sets, process 1100 may involve processor 812 selecting a PUCCH resource of the one or more PUCCH resource sets for the slow HARQ procedure based on a value in the ARI field.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
configuring, by a processor of an apparatus, one or more physical uplink control channel (PUCCH) resource sets for each sub-slot of multiple sub-slots within a slot; and
communicating, by the processor, with a wireless network by using a hybrid automatic repeat request (HARQ) procedure with the one or more PUCCH resource sets.

2. The method of claim 1, wherein the configuring of the one or more PUCCH resource sets for each sub-slot of the multiple sub-slots within the slot comprises applying a same PUCCH configuration to each sub-slot of the multiple sub-slots within the slot.

3. The method of claim 1, wherein the configuring of the one or more PUCCH resource sets for each sub-slot of the multiple sub-slots within the slot comprises:
applying a first PUCCH configuration to a first sub-slot of the multiple sub-slots; and
applying a second PUCCH configuration to a second sub-slot of the multiple sub-slots,
wherein the first PUCCH configuration and the second PUCCH configuration are different.

4. The method of claim 1, wherein the configuring of the one or more PUCCH resource sets for each sub-slot of the multiple sub-slots within the slot comprises configuring the one or more PUCCH resource sets for each sub-slot of the multiple sub-slots such that one of the one PUCCH resource of the one or more PUCCH resource sets crosses a sub-slot boundary between two adjacent sub-slots within the slot.

5. The method of claim 1, wherein the configuring of the one or more PUCCH resource sets for each sub-slot of the multiple sub-slots within the slot comprises configuring the one or more PUCCH resource sets for each sub-slot of the multiple sub-slots within each of one or more slots of a plurality of slots such that no PUCCH resource of the one or more PUCCH resource sets overlaps a downlink (DL) symbol or a slot boundary between two adjacent slots of the plurality of slots.

6. The method of claim 1, wherein the configuring of the one or more PUCCH resource sets for each sub-slot of the multiple sub-slots within the slot comprises:
receiving a signaling from the wireless network; and
configuring the one or more PUCCH resource sets for each sub-slot of the multiple sub-slots within the slot based on the signaling.

7. The method of claim 6, wherein the signaling comprises a radio resource configuration (RRC) signaling.

8. The method of claim 1, wherein the communicating by using the wireless network in the HARQ procedure with the one or more PUCCH resource sets comprises transmitting symbols of the one or more PUCCH resource sets such that each of the symbols is indexed with reference to a sub-slot boundary of a respective sub-slot of the multiple sub-slots.

9. The method of claim 1, wherein the communicating with the wireless network by using the HARQ procedure with the one or more PUCCH resource sets comprises:
selecting one of a plurality of different HARQ procedures based on an indication in an acknowledgement resource index (ARI) field in a downlink control information (DCI) signaling; and
communicating with the wireless network using the selected HARQ procedure.

10. The method of claim 9, wherein the selecting based on the indication in the ARI field comprises:
selecting a fast HARQ procedure from the plurality of different HARQ procedures for ultra-reliable low-latency communication (URLLC) based on a specific value in the ARI field that is reserved to indicate selection of the fast HARQ procedure,
wherein the configuring of the one or more PUCCH resource sets comprises selecting a PUCCH resource of the one or more PUCCH resource sets for the fast HARQ procedure based on a value of a HARQ_feedback timing indicator (K1), a size of a HARQ codebook, or an orthogonal frequency-division multiplexing (OFDM) symbol index of a first control channel element (CCE) carrying a last DCI signaling.

11. The method of claim 9, wherein the selecting based on the indication in the ARI field comprises:
selecting a second HARQ procedure from the plurality of different HARQ procedures for enhanced mobile broadband (eMBB),
wherein the configuring of the one or more PUCCH resource sets comprises selecting a PUCCH resource of the one or more PUCCH resource sets for the slow HARQ procedure based on a value in the ARI field.

12. A method, comprising:
receiving, by a processor of an apparatus, a signaling from a wireless network; and
providing, by the processor, a feedback to the wireless network responsive to the receiving of the signaling by performing a hybrid automatic repeat request (HARQ) procedure using at least one sub-slot of multiple sub-slots within a slot,
wherein a start symbol of each physical uplink control channel (PUCCH) resource used in the HARQ procedure is indexed with respect to a sub-slot boundary of the at least one sub-slot.

13. The method of claim 12, wherein the providing the feedback to the wireless network by performing the HARQ procedure comprises configuring one or more PUCCH resource sets for each sub-slot of the multiple sub-slots within the slot.

14. The method of claim 13, wherein the configuring of the one or more PUCCH resource sets for each sub-slot of the multiple sub-slots within the slot comprises applying a same PUCCH configuration to each sub-slot of the multiple sub-slots within the slot.

15. The method of claim 13, wherein the configuring of the one or more PUCCH resource sets for each sub-slot of the multiple sub-slots within the slot comprises:
applying a first PUCCH configuration to a first sub-slot of the multiple sub-slots; and
applying a second PUCCH configuration to a second sub-slot of the multiple sub-slots,
wherein the first PUCCH configuration and the second PUCCH configuration are different.

16. The method of claim 13, wherein the configuring of the one or more PUCCH resource sets for each sub-slot of the multiple sub-slots within the slot comprises configuring the one or more PUCCH resource sets for each sub-slot of the multiple sub-slots such that one of the one PUCCH resource of the one or more PUCCH resource sets crosses a sub-slot boundary between two adjacent sub-slots within the slot.

17. The method of claim 13, wherein the configuring of the one or more PUCCH resource sets for each sub-slot of the multiple sub-slots within the slot comprises configuring the one or more PUCCH resource sets for each sub-slot of the multiple sub-slots within each of one or more slots of a plurality of slots such that no PUCCH resource of the one or more PUCCH resource sets overlaps a downlink (DL) symbol or a slot boundary between two adjacent slots of the plurality of slots.

18. The method of claim 13, wherein the receiving of the signaling comprises receiving a radio resource configuration (RRC) signaling, and wherein the configuring of the one or more PUCCH resource sets for each sub-slot of the multiple sub-slots within the slot comprises configuring the one or more PUCCH resource sets for each sub-slot of the multiple sub-slots within the slot based on the RRC signaling.

19. A method, comprising:
receiving, by a processor of an apparatus, a downlink control information (DCI) signaling from a wireless network;
selecting, by the processor, one of a plurality of different hybrid automatic repeat request (HARQ) procedures based on an indication in an acknowledgement resource index (ARI) field in the DCI signaling; and
communicating, by the processor, with the wireless network by using the selected HARQ procedure with one or more physical uplink control channel (PUCCH) resource sets.

20. The method of claim 19, wherein the selecting based on the indication in the ARI field comprises:
selecting a fast HARQ procedure from the plurality of different HARQ procedures for ultra-reliable low-latency communication (URLLC) based on a specific value in an acknowledgement resource index (ARI) field that is reserved to indicate selection of the fast HARQ procedure, wherein the communicating by using the selected HARQ procedure with the one or more PUCCH resource sets comprises selecting a PUCCH resource of the one or more PUCCH resource sets for the fast HARQ procedure based on a value of a HARQ_feedback timing indicator (K1), a size of a HARQ codebook, or an orthogonal frequency-division multiplexing (OFDM) symbol index of a first control channel element (CCE) carrying a last DCI signaling; or
selecting a second HARQ procedure from the plurality of different HARQ procedures for enhanced mobile broadband (eMBB), wherein the communicating by using the selected HARQ procedure with the one or more PUCCH resource sets comprises selecting a PUCCH resource of the one or more PUCCH resource sets for the slow HARQ procedure based on a value in the ARI field.
